(19) United States
(12) Patent Application Publication
(10) Pub. No.: US 2009/0100897 A1
(43) Pub. Date: Apr. 23, 2009

(54) Confidence tester for sensor array detectors

(76) Inventors: John Albert Elton, Orange, CA (US); Timothy Edward Burch, San Gabriel, CA (US)

Correspondence Address: FOLEY AND LARDNER LLP;SUITE 500, 3000 K STREET NW, WASHINGTON, DC, 20007, US

(21) Appl. No.: 12/285,434

(22) Filed: Oct. 3, 2008

Related U.S. Application Data
(60) Provisional application No. 60/978,004, filed on Oct. 5, 2007.

(51) Int. Cl. G01N 37/00

(52) U.S. Cl. 73/1.03; 73/1.02

(57) ABSTRACT

A method of confidence testing in an uncontrolled environment using at least one test analyte in a container; placing the container adjacent to or connected to the detector, where the detector is configured to detect analytes within a threat library comprising the test analyte; releasing the test analyte from the container; detecting the test analyte with the detector; and comparing the detected test analyte with the threat library to determine whether the detector is operating correctly.

This application claims benefit to U.S. provisional patent application No. 60/978,004, filed Oct. 5, 2007 to Elton et al., which is hereby incorporated by reference in its entirety.

### SUMMARY OF THE INVENTION

The invention relates to a device and methodology for performing a confidence test (CT). A confidence tester allows a user to verify whether a chemical detector is operating correctly.

The device can be self-contained and is appropriate for a user to operate in the field, office, or a laboratory. In one aspect of the invention, the device can be operated by a user with limited technical training in an uncontrolled environment, where the user has minimal knowledge in how the device functions. Uncontrolled environments include, but are not limited to, locations considered to be in “the field,” such as a battlefield, warehouse, airport, or dock. The device and methodology allow a non-specialist user to easily verify the operational readiness of a chemical detector before using the detector.

One embodiment of the invention is a method of confidence testing by providing in an uncontrolled environment at least one test analyte in a container; placing the container adjacent to or connected to the detector, where the detector is configured to detect analytes within a threat library comprising the test analyte; releasing the test analyte from the container; detecting the test analyte with the detector; and comparing the detected test analyte with the threat library to determine whether the detector is operating correctly.

Another embodiment of the invention is a method of performing a confidence test by providing in an uncontrolled environment at least one test analyte in a container near or connected to a detector and releasing the test analyte from the container in a controlled manner, where the controlled manner is set by at least a self-supporting flow rate due to a property of the test analyte.

Another embodiment of the invention is a confidence test device including at least one chamber configured to receive a container; a seal covering the chamber; and a member configured to break the container by pressure or contact.

Another embodiment of the invention is a kit for applying a confidence test in an uncontrolled environment to determine whether a detector is operating correctly, including at least one container comprising a solution having a test analyte and a carrier containing the container, where the carrier is configured to retain remnants of the container after it is broken to release the test analyte.

### BRIEF DESCRIPTION OF THE DRAWINGS

FIG. 1. Response pattern of the chemical detector to 300 parts per million (ppm) of ammonia over a 2 minute period.

FIG. 2. Response pattern of the chemical detector to 6, 30, and 300 ppm of ammonia over a 2 minute period.

FIG. 3. Response pattern of the chemical detector to a 1% and 2% dilution of Windex headspace at 30% relative humidity (RH).

FIG. 4. Principal Component Analysis (PCA) results of the chemical detector to 2% Windex at 30% RH over a 2 minute period.

FIG. 5. PCA results of the chemical detector to 300 ppm ammonia over a 2 minute period.

FIG. 6. Confidence tester configuration used for generation of ammonia from ammonia inhalant ampoules into a chemical detector.

FIG. 7. Response pattern of the chemical detector to ammonia generated by the breakage of the ammonia inhalant ampoule with a vapor generator (VG) flow of 2 liters per minute (LPM) and a connector length of 11.5 cm.

FIG. 8. Response pattern of the chemical detector to ammonia generated by the breakage of the ammonia inhalant ampoule with a VG flow of 1 LPM and a connector length of 11.5 cm.

FIG. 9. Response pattern of the chemical detector to ammonia generated by the breakage of the ammonia inhalant ampoule with a VG flow of 0.5 LPM and a connector length of 11.5 cm.

FIG. 10. Response pattern of the chemical detector to ammonia generated by the breakage of the ammonia inhalant ampoule with a VG flow of 0.5 LPM and a connector length of 60 cm.

FIG. 11. Confidence tester configuration used for generation of ammonia from ammonia inhalant ampoules into a chemical detector without dilution or flow mixing.

FIG. 12. Response pattern of the chemical detector to ammonia generated by the breakage of the ammonia inhalant ampoule without dilution or flow mixing using ambient air and a connector length of 60 cm.

### DETAILED DESCRIPTION OF THE PREFERRED EMBODIMENTS

The confidence test device is preferably a self-contained unit and methods of using the device can preferably be performed by a non-specialist in the field.

“Confidence test” (CT) refers to a method of testing that verifies whether a detector is operating correctly.

“Confidence tester” refers to a device that provides at least one analyte in a form that can be readily detected by a detector for a confidence test. The confidence tester can be placed adjacent to the detector or can be connected to the detector. The confidence tester can also be self-contained. In some cases, the user is a non-specialist, which requires the confidence tester to be configured in a manner that is easy to use.

“Detector” refers to any sensor or sensor combination that can detect an analyte.

“Electronic nose” refers to a sensor array that produces a pattern of response when exposed to a chemical. This pattern of response is unique to that chemical and can be used by the detector to determine whether that chemical is present in the area of detection.

“Analyte” refers to any chemical compound that can be detected by a detector. The test analyte can be held in a container that is placed in the confidence tester. The container can be configured to release the test analyte in a number of ways, including via a releasable seal and a breakable material. The confidence tester can also contain a member that is configured to break the container.

“Smelling salts” refers to chemical compounds that are used to elicit a response from persons who have lost consciousness. Examples of smelling salts include ammonia and solutions containing ammonia.

“Field use” refers to use by end-users in an uncontrolled environment such as a battlefield, warehouse, airport, or dock.

“Uncontrolled environment” means an environment that is not secure or contained. Examples of a secure or contained environment include a general office or laboratory environment. An uncontrolled environment is thus distinct from a controlled office or laboratory environment.

One embodiment of the invention is a method of confidence testing by providing in an uncontrolled environment at least one test analyte in a container; placing the container adjacent to or connected to the detector, where the detector is configured to detect analytes within a threat library comprising the test analyte; releasing the test analyte from the container; detecting the test analyte with the detector; and comparing the detected test analyte with the threat library to determine whether the detector is operating correctly.

Another embodiment of the invention is a method of performing a confidence test by providing in an uncontrolled environment at least one test analyte in a container near or connected to a detector and releasing the test analyte from the container in a controlled manner, where the controlled manner is set by at least a self-supporting flow rate due to a property of the test analyte.

Another embodiment of the invention is a confidence test device comprising at least one chamber configured to receive a container; a seal covering the chamber; and a member configured to break the container by pressure or contact.

Another embodiment of the invention is a kit for applying a confidence test in an uncontrolled environment to determine whether a detector is operating correctly, comprising at least one container comprising a solution having a test analyte and a carrier containing the container, where the carrier is configured to retain remnants of the container after it is broken to release the test analyte.

In another embodiment, a tube connects from an outlet of the container to an inlet of the detector to allow the evaporating test analyte to reach the detector.

In another embodiment, additional flow is provided to bring the test analyte gas to the detector. The additional flow can be provided by ambient air or a secondary source. The secondary source of flow can be provided by a vapor generator that is attached to the confidence tester. The secondary source can also be separate from the confidence tester.

In another embodiment, the container can be broken before the chamber receives it.

In another embodiment, the container can be broken by the member after the chamber receives it.

In another embodiment, the container is an ampoule.

In another embodiment, the container is any type of open container.

In another embodiment, there are two containers, one to generate positive sensor response changes and the other to generate negative sensor response changes in a detector, such as an electronic nose. Different analytes and different concentrations of the same analyte may cause either positive or negative sensor changes from a background level. By testing both the positive and negative changes, the detector's operation can be functionally verified against different types and concentrations of analytes.

### Threat Library

The detector is configured to detect a plurality of analytes in a threat library. The threat library can include analytes that are considered to be dangerous to life and health. Such a threat library is useful in allowing the detector to sense whether dangerous analytes are present in a certain area. When sensed by the detector, each of the analytes produces a distinct response pattern. These response patterns are stored and can be used to determine whether a specific analyte is present in a certain area by comparing them with a response pattern generated through active detection. A positive match indicates that a specific analyte is present. The confidence test (CT) validates the detector's operation by testing at least one sensor in the detector.

In one embodiment, the test analyte is one of the plurality of analytes that the detector is configured to detect.

In another embodiment, a positive match between the test analyte's response pattern and the same analyte's stored response pattern indicates that the detector is operating correctly.

In another embodiment, the detector is an electronic nose.

In another embodiment, the CT provides at least two test analytes. In this embodiment, the CT can test detectors that have sensors that produce different changes in sensor response to the presence of analytes. Certain analytes will produce predominantly positive sensor response changes while other analytes will produce predominantly negative sensor response changes.

In another embodiment, one of the test analytes will produce primarily positive changes and the other test analyte will produce primarily negative changes.

In another embodiment the sensors are a plurality of sensors that are not necessarily of the same type. In this embodiment, the response pattern is derived from different sensor modalities that measure different physical or chemical characteristics of analytes.

### Test Analyte

The test analyte can be one of the compounds in the threat library. By using one of the compounds in the threat library as the test analyte and not a surrogate, the CT exercises the exact algorithm used to detect and alarm when sensing an area for one of the threat library analytes. The algorithm defines the response patterns that are associated with each analyte within the threat library. It also defines those response patterns that are associated with particular non-threat (interferent) environments and ambient air environments. These identified sets of response patterns are used to determine the closest response pattern match or lack of any match for an unknown response pattern. Unlike surrogate chemicals that can be used for confidence tests, using the actual chemical for confidence testing provides better certainty that a detector is operating correctly.

The algorithms applicable to the present methods include but are not limited to algorithms disclosed in U.S. Pat. Nos. 5,571,401; 5,788,833; 6,537,498; and 6,085,576, as applied to different types of sensors, each of which is hereby incorporated by reference in its entirety for all purposes.

U.S. Pat. Nos. 5,571,401 and 5,788,833 disclose chemical sensors useful for detecting analytes in a fluid (e.g., liquid, gas) as well as useful polymer-composite materials for polymer-composite sensor systems and devices. U.S. Pat. No. 6,537,498 shows colloidal particles and other materials useful in the sensors that can be tested using the confidence tester and methodology of the present invention.

In one aspect, the sensors include highly engineered sensors created from nanometer-sized carbon black particles stabilized with molecules or polymers attached directly to the carbon surface. These surface-modified carbon black (SMCB) sensor materials can be dispersed in a solvent and result in suspensions that preserve the nanometer-scale particles where typical carbon black/polymer dispersions aggregate at the micron size regime. These materials are highly suitable to the low-volume jetting processes of the present invention. In addition, the sensitivity of these materials is equal to or greater than similar composite sensors that do not utilize the surface modification approach. Extending this demonstrated capability to a range of chemically distinct sensing materials is advantageous.

Several other resistive-based sensing technologies are also compatible with the confidence tester. One specific sensing technology is intrinsically conducting polymers. While intrinsically conducting polymer sensors have been known for some time, historically these materials have been susceptible to moisture resulting in unreliable sensor performance. Recently, new materials have been fabricated for display purposes that show much greater stability to moisture. Traditionally, these intrinsically conducting materials have high sensitivity for certain high vapor pressure compounds including chlorine-, ammonia-, and sulfur-containing gases.

Another class of materials that is suitable for sensors that can be tested in the present invention is carbon nanotubes. The chemical detection capabilities of these materials have been recently reported (Kong, et al., Science, 287(5453):622 (2000)). In these reports, these materials are manually manipulated to lie between parallel electrodes. Furthermore, manufacturing variability of single nanotubes is very high. By averaging behavior over a number of nanotubes, single tube variability can be reduced or eliminated. This will lead to a more reliable and economical manufacturing path than has been previously demonstrated. In certain aspects, nanotubes are deposited directly from a solvent that completely evaporates. This approach focuses on using one or multiple nanotubes in a, single sensor.

Another set of materials that is used in one aspect is surface-modified colloidal metal particle sensors other than carbon black. These include surface-modified gold nanoparticles as chemical sensors similar to the surface-modified carbon blacks described above. These materials are often referred to as self-assembling monolayer (SAM) sensors since alkane thiols are often used as the surface modifier which form a monolayer on the metal surface. In one sensor that can be tested with the confidence tester of the present invention, polymer modified gold nanoparticles may be used as resistance based chemical sensors. The resistive read out provides a more robust measurement compared to optical detection that requires the alignment of lightsource, surface, and detector that currently limits these devices to laboratory use. A second advantage is that these materials are compatible with the sensing and deposition methodologies of the present invention. These materials have been demonstrated as effective sensors. The fabrication of these sensors is generally similar to that of the carbon-black-based systems. In certain aspects, an array of multiple, e.g., 32 sensors, is implemented in the devices that can be tested by the confidence tester of the present invention. However, arrays can be comprised of fewer sensors or even more sensors as desired for the particular application. For certain specific applications, an array of only four or five sensors is typically sufficient if sensors are appropriately selected. In some aspects, an array of sensors includes a single PCS sensor or multiple PCS sensors. Also, the array may include none, one or more other sensor types.

U.S. Pat. No. 6,085,576 discusses aspects of an example of a handheld sensor system, which includes a relatively large number of sensors incorporated in a handheld device that is intended to be used for a wide range of applications. One such sensor, the Cyranose.™ 320 (C320), is a COTS handheld vapor identification system that, in one aspect includes: (1) a polymer-composite sensor (PCS) array that returns a signature pattern for a given vapor, (2) a pneumatic system to present that vapor to the sensor array, and (3) implementations of pattern recognition algorithms to identify the vapor based on the array pattern. The C320 has been successfully tested as a point detector for TICs (e.g., hydrazine, ammonia, formaldehyde, ethylene oxide, insecticides) as well as CWAs (e.g., GA, GB, HN-3, VX).

Analytes may produce different response patterns, depending on their concentration. For some analytes, their response patterns will remain similar, but distinguishable, when detected by a detector. For other analytes, their profiles and/or magnitudes may change with different concentrations. For analytes with responses that can be distinguished between concentrations, the threat library can include these profiles so as to recognize high and low concentrations of analytes and determine whether the analytes are merely interferents or are dangerous and harmful.

In one embodiment, the test analyte is diluted. The dilution can be by either a solvent and/or water.

In another embodiment, the test analyte is concentrated.

In another embodiment, the test analyte is provided in diluted form that can be made more concentrated by applying a voltage to the solution.

In another embodiment, the test analyte is a smelling salt. Smelling salts and other commercially available compounds can be used to address safety concerns with using an actual analyte listed in the threat library.

In another embodiment, the test analyte can be ammonia or chlorine.

In another embodiment, the test analyte is capable of evaporating or diffusing from the solution.

In another embodiment, evaporation of the test analyte causes a constant flow of the analyte into the detector.

In another embodiment, a headspace is present above the solution in the container.

In another embodiment, a property of the test analyte includes a headspace pressure that is greater than one atmosphere.

In another embodiment, a property of the analyte is controlled by applying a voltage to the solution.

In another embodiment, the comparison between the response pattern of the test analyte and the response pattern of the analytes in the threat library can be electronic and performed within the detector.

A preferred threat library includes, but is not limited to:

| | |
|---|---|
| 1. | Dimethyl methyl phosphonate (DMMP) |
| 2. | Diisopropyl methyl phosphonate (DIMP) |
| 3. | Triethyl phosphate |
| 4. | Ammonia |
| 5. | Formaldehyde |
| 6. | Chlorine gas |
| 7. | Hydrogen cyanide |
| 8. | Cyanogen chloride |
| 9. | Ethylene oxide |
| 10. | Acrolein |
| 11. | Phosgene |
| 12. | Chloroethyl ethyl sulfide |
| 13. | Arsine |
| 14. | Acrylonitrile |
| 15. | Sulfur dioxide |
| 16. | Methyl isocyanate |
| 17. | o-chlorobenzylidene malononitrile (CS) |
| 18. | Parathion |
| 19. | Sarin |
| 20. | Tabun |
| 21. | Soman |
| 22. | Cyclosarin |
| 23. | Nerve gas VX |
| 24. | Blister agent HD |
| 25. | Nitrogen mustard (HN-1 to HN-3) |
| 26. | Lewisite |

### Example 1

### Response Pattern to Different Concentrations

An experiment was performed to calibrate the detector and determine its response characteristics with different concentrations of ammonia. This experiment was also performed to demonstrate that different concentrations of ammonia provide pattern responses that are sufficiently distinct to distinguish between the different ammonia concentrations. In this example, Windex vapors, an interferent vapor that has a relatively low concentration of ammonia, can be differentiated from stronger ammonia vapors that are within the threat library.

For the experiment, different ammonia vapor concentrations were used: 6, 30, and 300 ppm ammonia vapor. The vapors were at 30% relative humidity (RH). In addition, 1% and 2% gas dilutions (by volume) of Windex headspace vapor were generated and tested. Windex headspace vapor provides a comparatively diluted form of ammonia compared with the 30 and 300 ppm vapor concentrations generated from ammonia solutions. Comparatively, the 1% and 2% dilutions have concentrations roughly between 6 and 30 ppm ammonia vapor.

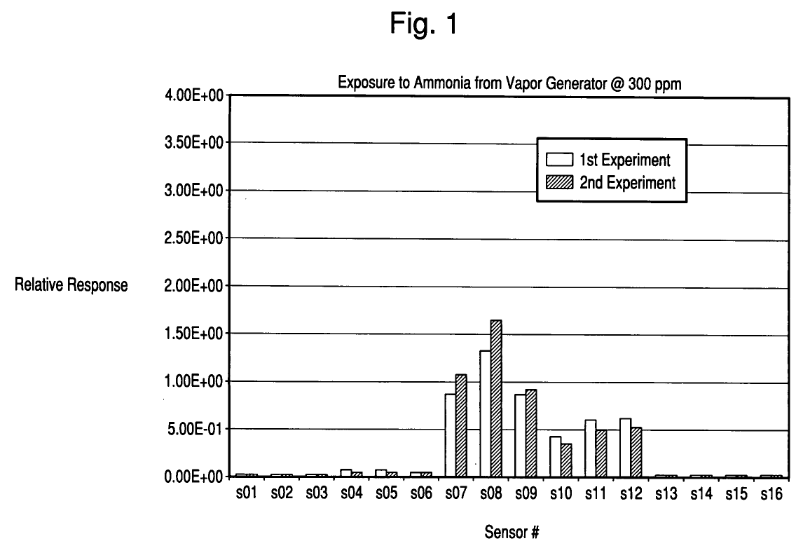

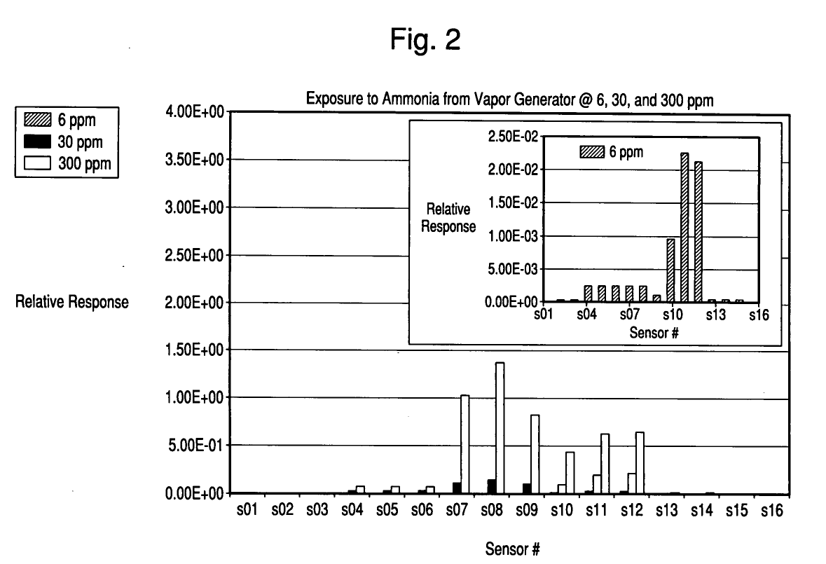

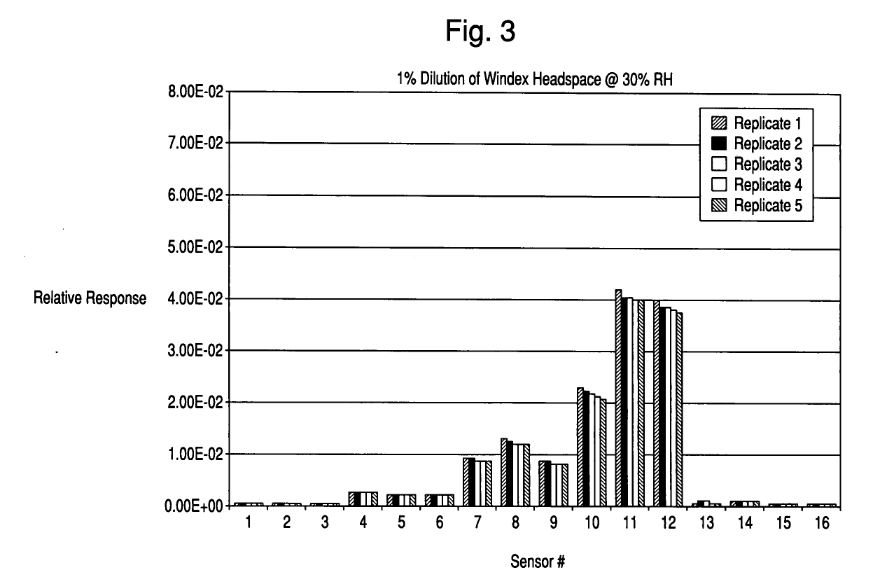

FIG. 1 illustrates the response pattern results from 300 ppm ammonia vapor, provided at a flowrate of 1 liters per minute (LPM). FIG. 2 illustrates the response pattern results from all three ammonia vapor concentrations, 6, 30, and 300 ppm, also at a flowrate of 1 LPM. FIG. 3 illustrates the response pattern from the 1% and 2% dilutions of Windex solution headspaces. Relative responses are provided in these figures to show the relationships between different concentrations and preparations.

From FIG. 2, it can be seen that the response patterns of different concentrations of ammonia differ in magnitude and/or profile for particular sets of sensors. For 300 ppm, sensors 7-9 show the largest responses, with lower responses from sensors 10-12. At the 30 ppm concentration, the magnitudes of the sensor responses are lower and there is a change in the response pattern. Sensors 10-12 show only a slightly larger response than sensors 7-9, which is distinct from that of the 300 ppm concentration. At the low concentration of 6 ppm, the magnitudes are even lower, with sensors 10-12 showing even larger responses generally than sensors 7-9. A shift in response patterns can therefore be clearly seen between the 300, 30, and 6 ppm concentrations.

From FIG. 3, it can be seen that the response pattern for the concentrations of ammonia in the diluted Windex headspace show even greater differences between the two sets of sensors, 7-9 and 10-12. In this response pattern, there is a general increase in signals in going from sensor set 7-9 to sensor set 10-12, with the overall magnitudes between sensors 7-9 and 10-12 much more distinguished at the lower 1% Windex headspace concentration. Comparatively, for the 300 ppm concentration, the reverse is seen, with sensors 7-9 showing the largest response magnitudes, followed by sensors 10-12.

### Principal Component Analysis

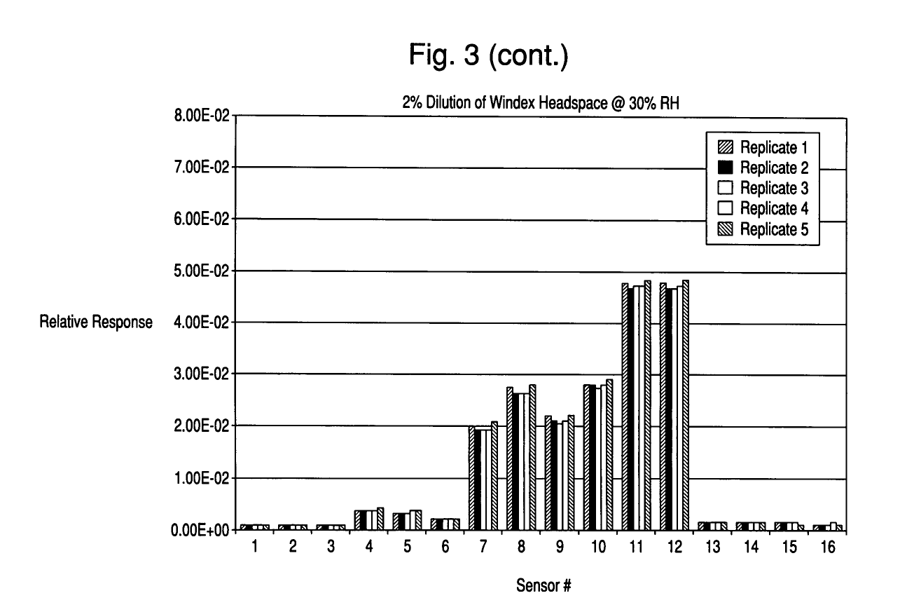

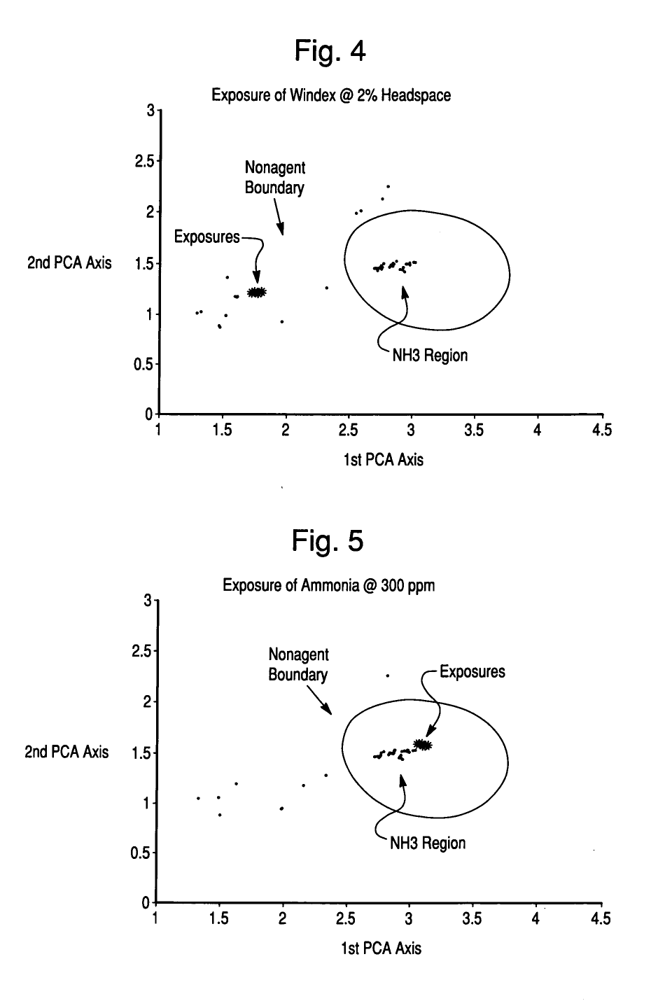

FIGS. 4-5 illustrates that Principal Component Analysis (PCA) also shows differentiation between 2% Windex and ammonia at higher concentrations by indicating different locations of the responses. In both figures, four different elements are detected as shown: background (Nonagent Boundary, which determines the boundary where detection switches from ammonia and Windex to Nonagent), Windex (Windex Region), ammonia (NH₃ Region), and either 2% Windex or 300 ppm ammonia exposures (Exposures). The Nonagent Boundary, Windex and NH₃ are the same in both figures and used as references to compare the 2% Windex and 300 ppm ammonia samples. As can be seen in FIG. 4, the PCA results for 2% Windex show their concentration to be in the left-center region of the plot (Windex Region). In FIG. 5, the PCA results for the 300 ppm ammonia show their concentration to be in the right-hand region (NH3 Region).

The detector therefore produces a different response pattern at different concentrations of the same chemical compound. In addition to magnitude differences, the actual response pattern can change. A CT using a specific test analyte could therefore incorporate different concentrations of the same analyte to test the detector's ability to sense different vapor concentrations of the same analyte based on both magnitude and response patterns.

The shift in pattern strength demonstrated in FIGS. 1-5 allows interferents having low concentrations of ammonia, like diluted Windex headspace, to be differentiated from threat analytes having higher concentrations of ammonia. The application of pattern shifts to a confidence test is not limited to ammonia. While other analytes may have different response patterns, the confidence test can be applied to any analyte that is capable of producing distinguishable sensor responses based on a difference in concentration. The threat library can therefore include response patterns to different concentrations of the same analyte, thereby causing the detector to alarm at certain concentrations of the analyte while rejecting the same analyte when it is at a lower concentration that is not within the threat library.

### Example 2

An experiment using commercial ampoules of ammonia was performed (First Aid Only, Inc., Vancouver, Wash.). Ammonia Inhalant Ampoules were packaged with 10 ammonia inhalant ampoules in each package, the contents of each ampoule as provided below regarding solution composition. Ammonia inhalants can be used to provide ammonia vapor to the flow going into a detector system and thereby used as a means of providing a consistent and defined confidence tester (CT) source. The ampoules contain 0.3 ml of liquid within an approximately 1.2 ml ampoule and have an estimated headspace pressure of about 2.4 atm.

These ampoules had the following approximate solution composition:

| | |
|---|---|
| Ammonia | 18.5% w/w |
| Ethyl Alcohol | 37.5% v/v |
| Water | 37.0% v/v |

Experiments were performed using the following general procedure:

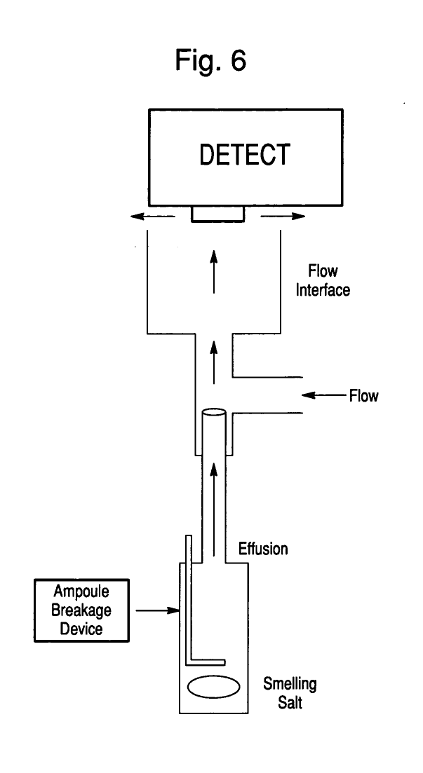

As shown in FIG. 6, the ampoules were placed into a CT unit and the unit was connected to a bell jar (Flow Interface Component). The experiment was started using a 30% RH background flow from the vapor generator at specified flow rates to the bell jar. This flow was continuously sampled by the detector unit. The background flow was run for 5 minutes, after which the ampoule was broken to release the ammonia vapor. Exposure of ammonia vapor to the detector was continued for two minutes, after which the CT was removed and a cap placed on the CT connection of the bell jar. Background flow was continued for a minimum of 10 minutes.

Breaking the ampoule generates a small pulse of ammonia vapor that is followed by continuous evaporation of the ammonia from the solution. This evaporation generates a continuous small flow of the concentrated ammonia vapor that can be mixed with air or other vapors before being provided to the detector. The detector samples a controlled fraction of the diluted ammonia flowing from the CT and uses the response pattern obtained to identify the ammonia vapor and validate correct operation of the detector.

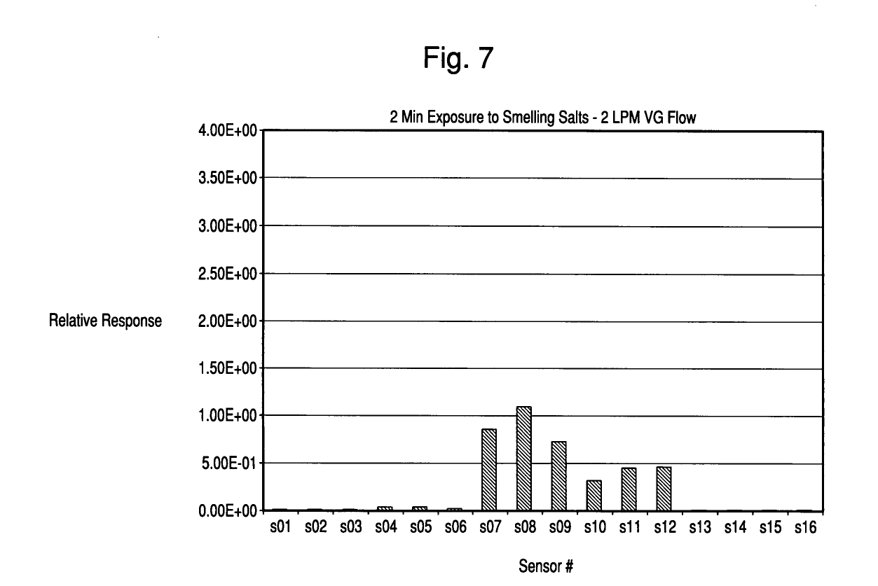

For this experiment, a 11.5 cm. long ⅛″ Teflon tube connector was placed between the CT and the detector. Three sets of flow rates were provided at 30% RH: 2 LPM, 1 LPM, and 0.5 LPM. The results are illustrated in FIGS. 7-9 for each flowrate, respectively.

FIG. 7 shows the results of a 2 LPM flowrate. The close similarity of the response pattern and magnitudes to the results of the 300 ppm ammonia solution of Example 1 (FIGS. 1-2) indicates that the average concentration entering the detector after ampoule breakage is approximately 250 ppm.

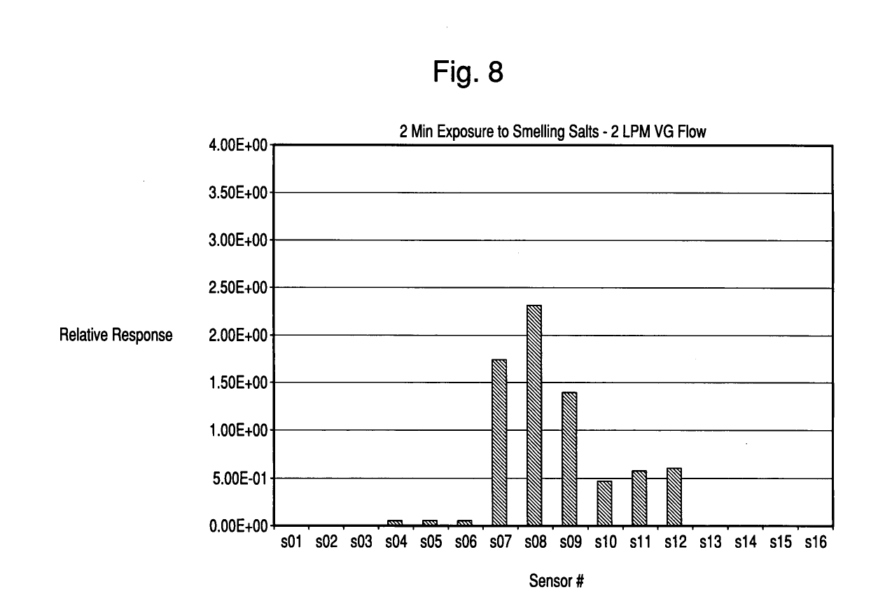

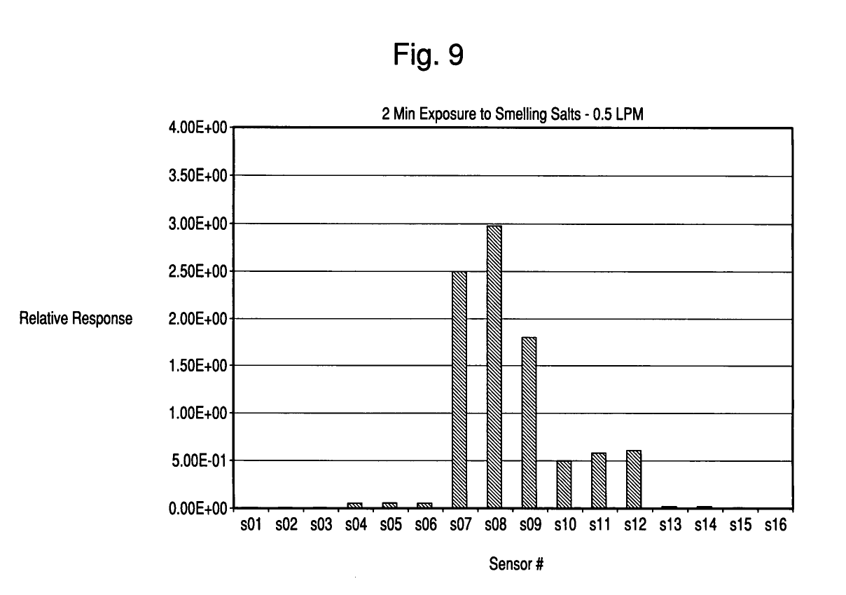

FIGS. 8-9 show the results of 1 and 0.5 LPM flowrates, respectively. These results demonstrate CT generation of an analyte vapor by breaking a container using pressure or contact. These results are also in agreement with the response pattern comparisons made in Example 1, where as concentration increases, sensors 7-9 become more predominant than sensors 10-12.

### Example 3

An experiment using the same commercial ampoules as in Example 2 was performed. A 60 cm. long ⅛″ Teflon tube connector was placed between the CT and the detector and a total flow of 0.5 LPM was provided at 30% RH. The only difference between this experiment and the 0.5 LPM flowrate of Example 2 is the length of tubing used to connect the CT with the detector. This difference was expected to produce a difference in the magnitude of the sensor responses due to diffusion effects. However, the resulting evidence indicated the unexpected phenomenon of a constant flowrate, likely due to ammonia evaporation and pressure from the ampoule.

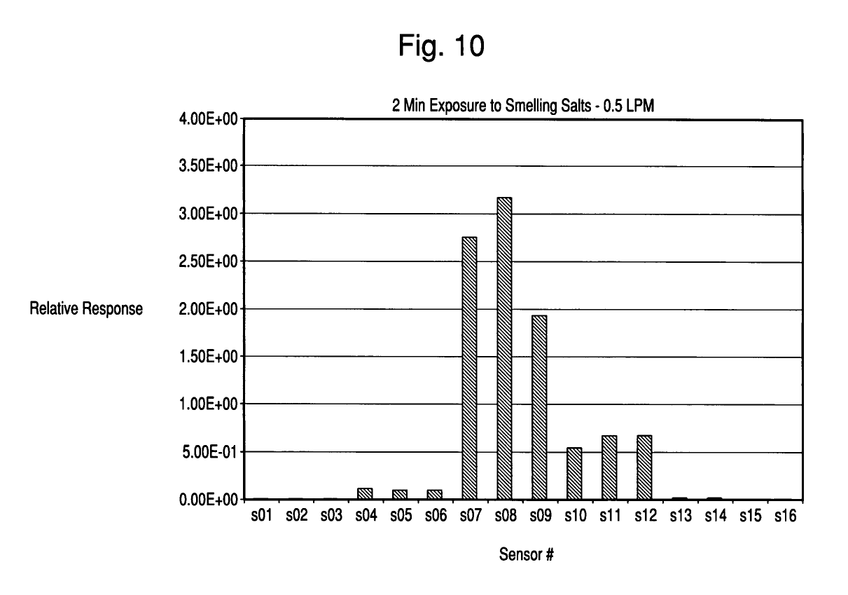

The results are illustrated in FIG. 10. Without intending to be bound by theory, it is believed that the observation of almost no change in the response magnitudes between FIGS. 9 and 10 indicate strongly that the delivery of the ammonia vapors to the detectors is not diffusion-based, because an approximately 4× decrease in magnitude would have been expected if the 11.5 cm. and 60 cm. connector tubes acted as the capillary portion of a diffusion tube. As a result of what occurred, the delivery of the ammonia from the ammonia inhalant ampoule is believed to be due to both the pressure within the ampoule and the evaporation of the ammoniacal solution.

While this invention is not intended to be bound by theory, it is believed that the above experiments demonstrate the following:

1. A confidence tester can use ammonia inhalant ampoules for the generation of ammonia at concentrations that are easily detected by chemical detectors.

2. The generation of ammonia by a confidence tester using ammonia inhalant ampoules is dependent upon both pressure and evaporation effects.

3. This evaporation of the ammoniacal solution provides the primary mechanism for the generation of ammonia within the confidence tester. A diffusion mechanism was initially expected since long connection tubes (1.5 and 60 cm) of relatively small inside diameter ( 1/16 inch) were being used in these experiments. Because the ammonia solution within the ammonia inhalant ampoules was diluted with water and ethanol (˜75% by volume), it was not anticipated that the headspace would be above 1 atm total pressure. This was only determined, identified and understood after the experiments with the two connection tubes were performed showing that a mechanism other than diffusion was generating the ammonia. This mechanism would therefore not be generally expected by persons of ordinary skill in this field.

### Example 4

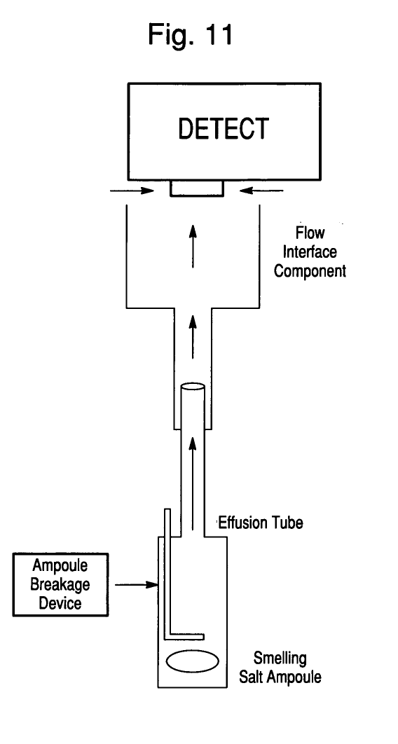

An experiment using the same commercial ampoules as in Examples 2 and 3 was performed. This experiment did not utilize the vapor generator, but pulled sample flow from the ambient environment. The CT device was connected directly to the input of the bell jar with no flow being provided to the bell jar (flow interface component). All of the ammonia vapor provided by the CT device was drawn into the detector unit. This setup is depicted in FIG. 11.

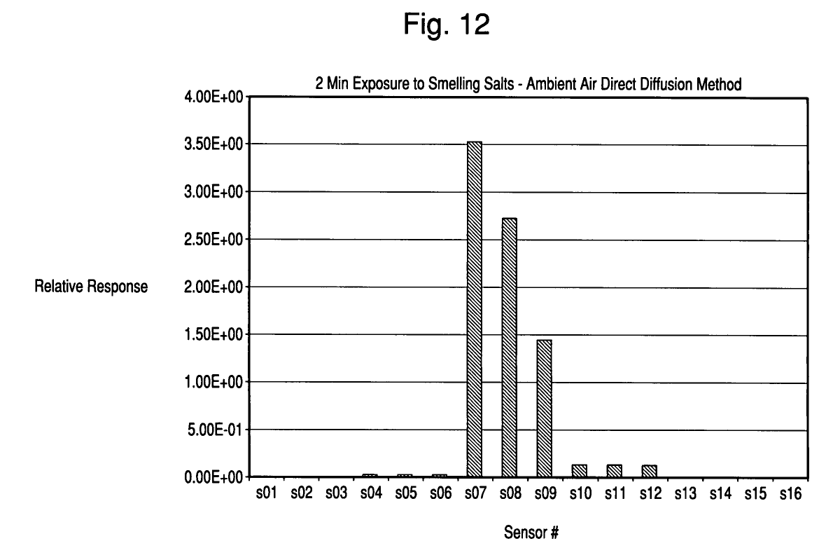

FIG. 12 illustrates the results of the experiment. Without intending to be bound by theory, it appears that this experiment shows that evaporation was the primary driving force producing the ammonia vapor flow from the CT device. The experiment was set up so that no dilution flow was being provided at the output of the CT device. As a result only “diffusion flow” was expected to provide ammonia to the input of the detector. With a 60 cm long connector tube it was expected that only a small flow would be generated from this setup if diffusion was the driving force for ammonia generation and transport. However, this was not the case because the response magnitude of the sensors in this experiment was approximately ten times that from the previous experiment with only a 0.5 LPM dilution flow using a 60 cm long connector tube (FIG. 10). Evaporation had to be occurring at a fairly significant rate such that significant ammonia flow was being generated and transported to the input of the detector.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A method of confidence testing comprising:
a) providing in an uncontrolled environment at least one test analyte in a container;
b) placing the container adjacent to or connected to the detector, wherein the detector is configured to detect analytes within a threat library comprising the test analyte;
c) releasing the test analyte from the container;
d) detecting the test analyte with the detector; and
e) comparing the detected test analyte with the threat library to determine whether the detector is operating correctly.

2. A method of performing a confidence test comprising:
a) providing in an uncontrolled environment at least one test analyte in a container near or connected to a detector and
b) releasing the test analyte from the container in a controlled manner, wherein the controlled manner is set by at least a self-supporting flow rate due to a property of the test analyte.

3. A confidence test device comprising:
a) at least one chamber configured to receive a container;
b) a seal covering said chamber; and
c) a member configured to break the container by pressure or contact.

4. A kit for applying a confidence test in an uncontrolled environment to determine whether a detector is operating correctly, comprising:
a) at least one container comprising a solution having a test analyte and
b) a carrier containing the container, wherein the carrier is configured to retain remnants of the container after it is broken to release the test analyte.
